(19) United States
(12) Patent Application Publication
(10) Pub. No.: US 2026/0131252 A1
(43) Pub. Date: May 14, 2026

(54) INTERACTION PROCESSING METHOD AND APPARATUS FOR VIRTUAL SCENE, ELECTRONIC DEVICE, COMPUTER-READABLE STORAGE MEDIUM, AND COMPUTER PROGRAM PRODUCT

(71) Applicant: Tencent Technology (Shenzhen) Company Limited, Shenzhen (CN)

(72) Inventor: Ziqi WEI, Shenzhen (CN)

(21) Appl. No.: 19/442,956

(22) Filed: Jan. 7, 2026

Related U.S. Application Data
(63) Continuation of application No. PCT/CN2024/113638, filed on Aug. 21, 2024.

(30) Foreign Application Priority Data
Oct. 19, 2023 (CN) 202311362098.0

(51) Int. Cl. A63F 13/69; A63F 13/52; A63F 13/56; A63F 13/67; G06T 19/20

(52) U.S. Cl. CPC A63F 13/69; A63F 13/52; A63F 13/56; A63F 13/67; G06T 19/20; G06T 2219/2004

(57) ABSTRACT

This application provides a method for processing an interaction in a virtual scene performed by an electronic device. The method includes: displaying a virtual scene, the virtual scene including a first account and a second account that participate in interaction; displaying at least one first cell and at least one second cell in the virtual scene, the first cell being configured for the first account to place at least one first virtual object, to interact with at least one second virtual object placed in the second cell by the second account; and in response to an end of each round of interaction, updating a quantity of cells included in the virtual scene.

### CROSS-REFERENCE TO RELATED APPLICATIONS

This application is a continuation application of PCT Patent Application No. PCT/CN2024/113638, entitled “INTERACTION PROCESSING METHOD AND APPARATUS FOR VIRTUAL SCENE, ELECTRONIC DEVICE, COMPUTER-READABLE STORAGE MEDIUM, AND COMPUTER PROGRAM PRODUCT” filed on Aug. 21, 2024, which claims priority to Chinese Patent Application No. 202311362098.0, entitled “INTERACTION PROCESSING METHOD AND APPARATUS FOR VIRTUAL SCENE, ELECTRONIC DEVICE, COMPUTER-READABLE STORAGE MEDIUM, AND COMPUTER PROGRAM PRODUCT” filed on Oct. 19, 2023, all of which are incorporated herein by reference in their entirety.

### FIELD OF THE TECHNOLOGY

This application relates to the technical field of human-computer interaction of computers, and in particular, to an interaction processing method and apparatus for a virtual scene, an electronic device, a computer-readable storage medium, and a computer program product.

### BACKGROUND OF THE DISCLOSURE

A display technology based on graphics processing hardware has expanded channels for environmental perception and information acquisition. Especially, a display technology of a virtual scene can implement, based on an actual application requirement, diversified interactions between virtual objects that are controlled by users or artificial intelligence, and has various typical application scenarios, for example a virtual scene such as a game, in which a real battle process between virtual objects can be simulated.

Auto chess games are taken as an example. Generally, game manners in which chess pieces are placed to perform a battle are collectively referred to as auto chess games. Players use chess pieces to battle against each other and win. The core fun of the auto chess game lies in combinations between different chess pieces, and each chess piece has a unique skill mechanism and battle mechanism. In addition, chess pieces in the auto chess usually battle on two opposing sides of a chessboard. An area in which chess pieces battle is referred to as a battle area, and an area in which chess pieces are not placed is referred to as a preparation area.

In a related technology, a chessboard of auto chess usually has a fixed structure. That is, the quantity of tiles included in the chessboard is fixed, and a player can place chess pieces to battle only on a fixed quantity of tiles. However, the player needs different quantities of tiles at different stages of the game. For example, a relatively small quantity of tiles is needed at an early stage of the game, and an increasing quantity of tiles are needed as the game progresses. It can be seen that such a solution with a fixed quantity of tiles provided in the related technology undoubtedly causes resource waste due to the display of unnecessary tiles.

### SUMMARY

Embodiments of this application provide an interaction processing method and apparatus for a virtual scene, an electronic device, a computer-readable storage medium, and a computer program product. The quantity of cells in the virtual scene can be dynamically adjusted according to the game progress, thereby avoiding resource waste caused by the display of unnecessary cells.

Technical solutions of the embodiments of this application are implemented as follows:

An embodiment of this application provides a method for processing an interaction in a virtual scene, executed by an electronic device, including:
displaying a virtual scene, the virtual scene including a first account and a second account that participate in interaction;
displaying at least one first cell and at least one second cell in the virtual scene, the first cell being configured for the first account to place at least one first virtual object, to interact with at least one second virtual object placed in the second cell by the second account; and
updating, in response to an end of each round of interaction, a quantity of cells included in the virtual scene.

An embodiment of this application provides an electronic device, including:
a memory, configured to store a computer-executable instruction or a computer program; and
a processor, configured to implement, when executing the computer-executable instruction or the computer program stored in the memory, a method for implementing an interaction processing in a virtual scene provided in the embodiment of this application.

An embodiment of this application provides a non-transitory computer-readable storage medium, having a computer-executable instruction or a computer program stored therein. The computer-executable instruction or the computer program, when executed by a processor of an electronic device, causes the electronic device to implement the interaction processing method for a virtual scene provided in the embodiment of this application.

The embodiments of this application have the following beneficial effects:

The embodiments of this application provide a brand new interaction manner in a virtual scene. After the end of each round of interaction, the quantity of cells in the virtual scene is controlled to change. That is, in the technical solutions provided in the embodiments of this application, the quantity of cells in the virtual scene is not fixed, but continuously changes as the game progresses. That is, the quantity of cells in the virtual scene adapts to the game progress. In this way, compared with the mode of a fixed quantity of cells provided in the related technology, the technical solutions provided in the embodiments of this application can avoid resource waste caused by the display of unnecessary cells.

### BRIEF DESCRIPTION OF THE DRAWINGS

FIG. 1 is a schematic architecture diagram of an interaction processing system 100 for a virtual scene according to an embodiment of this application.

FIG. 2 is a schematic structural diagram of an electronic device 500 according to an embodiment of this application.

FIG. 3 is a first schematic flowchart of an interaction processing method for a virtual scene according to an embodiment of this application.

FIG. 4A is a second schematic flowchart of an interaction processing method for a virtual scene according to an embodiment of this application.

FIG. 4B is a third schematic flowchart of an interaction processing method for a virtual scene according to an embodiment of this application.

FIG. 4C is a fourth schematic flowchart of an interaction processing method for a virtual scene according to an embodiment of this application.

FIG. 4D is a fifth schematic flowchart of an interaction processing method for a virtual scene according to an embodiment of this application.

FIG. 4E is a sixth schematic flowchart of an interaction processing method for a virtual scene according to an embodiment of this application.

FIG. 5A is a schematic diagram of a first application scenario of an interaction processing method for a virtual scene according to an embodiment of this application.

FIG. 5B is a schematic diagram of a second application scenario of an interaction processing method for a virtual scene according to an embodiment of this application.

FIG. 5C is a schematic diagram of a third application scenario of an interaction processing method for a virtual scene according to an embodiment of this application.

FIG. 5D is a schematic diagram of a fourth application scenario of an interaction processing method for a virtual scene according to an embodiment of this application.

FIG. 6 is a seventh schematic flowchart of an interaction processing method for a virtual scene according to an embodiment of this application.

The foregoing “first” and “second” are only used to distinguish different solutions, and do not represent superiorities of the solutions or priorities in an implementation process.

### DESCRIPTION OF EMBODIMENTS

To make objectives, technical solutions, and advantages of this application clearer, the following further describes this application in detail with accompanying drawings. The described embodiments do not be construed as limitation on this application. All other embodiments obtained by a person of ordinary skill in the art based on the embodiments of this application without creative efforts shall fall within the protection scope of this application.

In the following descriptions, the term “some embodiments” describes subsets of all possible embodiments, but “some embodiments” may be the same subset or different subsets of all the possible embodiments, and may be combined with each other without conflict.

In embodiments of this application, related data (for example, data of a game character controlled by a user) such as user information is involved. When a specific product or technology is applied to this embodiment of this application, a user's permission or consent is required, and acquisition, use, and processing of the relevant data need to comply with the relevant laws and standards of the relevant countries and regions.

In the embodiments of this application, a term “module” or “unit” refers to a computer program having a predetermined function or a part of the computer program, and operates together with other relevant parts to achieve a predetermined objective, and may be all or partially implemented by using software, hardware (such as a processing circuit or a memory), or a combination thereof. Similarly, one processor (or a plurality of processors or memories) may be configured to implement one or more modules or units. In addition, each module or unit may be a part of an overall module or unit including a function of the module or unit.

In the following descriptions, the involved term “first/second . . . ” is merely intended to distinguish similar objects but does not necessarily indicate a specific order of an object. “First/second . . . ” is interchangeable in terms of a specific order or sequence if permitted, so that the embodiments of this application described here can be implemented in a sequence in addition to the sequence shown or described here.

Unless otherwise defined, meanings of all technical and scientific terms used herein are the same as those usually understood by those skilled in the art to which this application belongs. The terms used in this specification are merely intended to describe the embodiments of this application, but are not intended to limit this application.

Before the embodiments of this application are further described in detail, nouns and terms involved in the embodiments of this application are described, and the following explanations are applicable to the nouns and terms involved in the embodiments of this application.

(1) In response to: The term “in response to” is configured for representing a condition or status on which one or more operations-to-be-performed depend. When the condition or status is met, the one or more operations may be performed immediately or after a set delay. Unless otherwise specified, there is no requirement for a chronological order of execution for the plurality of operations-to-be-performed.

(2) Virtual scene: A virtual scene is a scene displayed (or provided) when an application runs on a terminal. The scene may be a simulated environment of a real world, or may be a semi-simulated and semi-fictional virtual environment, or may be a completely fictional virtual environment. The virtual scene may be any one of a two-dimensional virtual scene, a 2.5-dimensional virtual scene, or a three-dimensional virtual scene. The dimension of the virtual scene is not limited in the embodiments of this application. For example, the virtual scene may include the sky, the land, the ocean, and the like. The land may include an environment element like a desert or a city, and a user may control a virtual object to move in the virtual scene.

(3) Virtual object: Virtual objects are avatars of various people and objects that may perform interaction within the virtual scene, or movable objects in the virtual scene. The movable object may be a virtual character, a virtual animal, a cartoon character, or the like, for example, a character or an animal displayed in a virtual scene. The virtual object may be a virtual avatar representing the user in the virtual scene, for example, a virtual chess piece displayed in a virtual chessboard. The virtual scene may include a plurality of virtual objects. Each virtual object has a shape and a volume of the virtual object in the virtual scene, and occupies a part of space in the virtual scene.

(4) Scene data: Scene data represents feature data of a virtual scene. For example, the scene data may be an area of a construction area in the virtual scene, a current building style of the virtual scene, or the like; or may include a position of a virtual building in the virtual scene, an area occupied by the virtual building, and the like.

(5) Auto chess game: An auto chess game is a new multiplayer battle strategy game. A user may set up and cultivate lineups of chess pieces to battle against the opponent's lineups. The losers have their health points deducted. When the health points fall below a threshold, this user is eliminated. The ranking is determined based on the order of elimination.

(6) Virtual chess pieces: Virtual chess pieces, chess pieces for short, are different battle units in an auto chess game. The user may perform operations, such as equipping, upgrading, buying, selling, and position adjustment, on the virtual chess pieces.

(7) Virtual chessboard: Each user corresponds to one home chessboard, and sets up a lineup on the home chessboard during the preparation period. When the battle begins, a portal transports the user's virtual chess pieces to the opponent's home chessboard (transports, in some cases, the opponent's virtual chess pieces to the user's home chessboard) for battle.

(8) Cloud gaming: Cloud gaming is also referred to as gaming on demand, that is, a game program is deployed in a server, an instance of the game program (briefly referred to as a game instance) is run, the game instance sends game data outputted in a running process to a page of a browser of a user terminal, and the page invokes a media component of the browser to decode the game data, and renders a real-time game screen in a game process according to a decoding result. When the page monitors an operation performed by the user in the game screen, the page reports the operation to the game instance running in the server. When game data of a response operation generated by the game instance is received, the decoding and rendering process is repeated, so that the change of the game screen according to the operation of the user is presented on the page.

That is, a cloud game is an online gaming technology based on a cloud computing technology. The cloud gaming technology enables a thin client with relatively limited graphics processing and data computing capabilities to run high-quality games. In a cloud game scene, a game is not run in a user terminal (for example, a player game terminal), but is run in a cloud server, and the cloud server renders the game scene into an audio and video stream and transmits the audio and video stream to the user terminal by using a network. In this way, the user terminal does not need to have a strong graphic operation capability and a data processing capability, and only needs to have a basic streaming media play capability and a capability of obtaining a player input instruction and sending the player input instruction to the cloud server.

Auto chess games are taken as an example. Game manners in which chess pieces (i.e., virtual objects) are placed to perform a battle are collectively referred to as auto chess games. Players may use chess pieces to battle against each other and win. The core fun of the auto chess game lies in combinations between different chess pieces, and each chess piece has a unique skill mechanism and battle mechanism. Chess pieces in the auto chess game usually battle on two opposing sides of a chessboard. An area in which chess pieces battle is referred to as a battle area, and an area in which chess pieces are not placed is referred to as a preparation area.

A chessboard of auto chess games in the related technology usually has a fixed structure. That is, the quantity of tiles in the chessboard is fixed, and a player places chess pieces to battle on corresponding tiles. However, in a process of implementing this embodiment of this application, the applicant finds that the fixed quantity of tiles has some limitations to gameplay expansion, and the player is prone to be bored. In addition, the applicant further finds that by breaking down the chessboard modality, for example, through interesting gameplay that enlarges the chessboard area by battling, the original fixed chessboard mode is broken, allowing players to have more tactical gameplay options and increasing the possibility of the chessboard as a gameplay carrier.

In view of this, embodiments of this application provide an interaction processing method and apparatus for a virtual scene, an electronic device, a non-transitory computer-readable storage medium, and a computer program product. The quantity of cells in the virtual scene can be dynamically adjusted according to the game progress, thereby avoiding resource waste caused by the display of unnecessary cells. The following describes the electronic device provided in the embodiments of this application. The electronic device provided in the embodiments of this application may be implemented as a terminal device, or may be implemented collaboratively by a server and a terminal device. A description is provided below by using an example in which the server and the terminal device collaboratively implement the interaction processing method for a virtual scene provided in the embodiments of this application.

Before introducing the architecture of the interaction processing system for a virtual scene provided in the embodiments of this application, a game mode involved in the embodiments of this application is first described. A solution for cooperative implementation of the terminal device and the server mainly involves two game modes, namely, a local game mode and a cloud game mode. The local game mode means that the terminal device and the server cooperatively run game logic processing. Some operation instructions inputted by a player into the terminal device are used by the terminal device to run game logic processing, and some other operation instructions are used by the server to run game logic processing. In addition, game logic processing run by the server is usually more complex and needs to consume more computing power. The cloud game mode means that game logic processing is completely run by the server (such as a cloud server), and game scene data is rendered into audio and video streams by the cloud server, and the audio and video streams are transmitted to the terminal device via a network for display. That is, the terminal device only needs to have a basic streaming media play capability and a capability of obtaining an operation instruction of a player and sending the operation instruction to the server.

The following describes the architecture of the interaction processing system for a virtual scene according to the embodiments of this application.

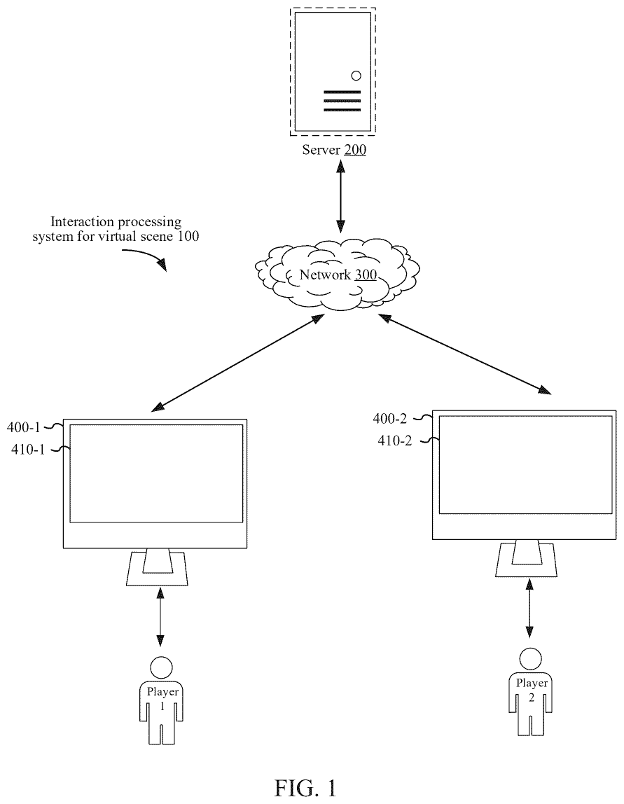

Exemplarily, referring to FIG. 1, FIG. 1 is a schematic architecture diagram of an interaction processing system 100 for a virtual scene according to an embodiment of this application, in order to implement an application that supports enrichment of interaction manners of the virtual scene and further improves game experience of players. As shown in FIG. 1, the interaction processing system 100 for a virtual scene includes: a server 200, a network 300, a terminal device 400-1, and a terminal device 400-2. The network 300 may be a local area network, a wide area network, or a combination thereof. The terminal device 400-1 is a terminal device associated with Player 1. A client 410-1 runs on the terminal device 400-1. The terminal device 400-2 is a terminal device associated with Player 2. A client 410-2 runs on the terminal device 400-2. The client 410-1 and the client 410-2 are the same type of clients. Using the client 410-1 as an example, the client 410-1 may be various types of clients, for example, including an auto chess game client, a multiplayer strategy game client, and a browser.

In some embodiments, the terminal device 400-1 associated with Player 1 is taken as an example. A virtual scene (for example, a virtual chessboard) may be displayed on a human-computer interaction interface of the client 410-1 running on the terminal device 400-1. The virtual scene may include a first account (for example, Game Account 1 pre-registered by Player 1) and a second account (for example, Game Account 2 pre-registered by Player 2) that participate in interaction. Next, the client 410-1 may display at least one first cell and at least one second cell in the virtual scene. The first cell may be configured for the first account to place at least one first virtual object (for example, chess piece), to interact with at least one second virtual object placed in the second cell by the second account. Subsequently, when detecting an end of each round of interaction, the client 410-1 may update the quantity of cells included in the virtual scene, for example, add at least one first cell and at least one second cell to the virtual scene. That is, as the game progresses, the structure of the chessboard changes accordingly. In this way, interaction manners of the virtual scene are enriched, and resource waste caused by the display of unnecessary cells is avoided.

This embodiment of this application may rely on the computing power of the server 200 to complete the virtual scene calculation, and output the virtual scene at the terminal device 400-1 (for example, invoke the human-computer interaction interface of the client 410-1 for display). Using an example in which visual perception of the virtual scene is formed, the server 200 calculates display data (for example, scene data) related to the virtual scene and sends the display data to the terminal device 400-1 via the network 300. The terminal device 400-1 relies on graphics computing hardware to complete loading, parsing, and rendering for calculating the display data, and relies on graphics output hardware to output the virtual scene to form visual perception. For example, a two-dimensional video frame may be presented on a display screen of a smartphone, or a video frame having a three-dimensional display effect may be projected on lenses of augmented reality/virtual reality glasses. For perception in the form of the virtual scene, the virtual scene may be outputted through corresponding hardware of the terminal device 400-1, for example, auditory perception may be formed by using a microphone, and tactile perception may formed by using a vibrator.

In some other embodiments, the embodiments of this application may further be implemented by using a cloud technology. The cloud technology is a hosting technology that unifies a series of resources such as hardware, software, and networks in a wide area network or a local area network to implement computing, storage, processing, and sharing of data.

Cloud technology is a general term for a network technology, an information technology, an integration technology, a management platform technology, an application technology, and the like that are applied based on a cloud computing business model. The technologies can form a resource pool to be flexibly used on demand. A cloud computing technology becomes an important support. A backend service of a technical network system needs a large quantity of computing and storage resources.

Exemplarily, the server 200 in FIG. 1 may be an independent physical server, or may be a server cluster or a distributed system formed by a plurality of physical servers, or may be a cloud server that provides basic cloud computing services such as a cloud service, a cloud database, cloud computing, a cloud function, cloud storage, a network service, cloud communication, a middleware service, a domain name service, a security service, a content delivery network (CDN), big data, and an artificial intelligence platform. The terminal device 400-1 and the terminal device 400-2 may be a smartphone, a tablet computer, a notebook computer, a desktop computer, a smart sound box, a smart watch, an in-vehicle terminal, a virtual reality device, an augmented reality device, or the like, but are not limited thereto. The terminal device 400-1, the terminal device 400-2, and the server 200 may be directly or indirectly connected through wired or wireless communication, which is not limited in this embodiment of this application.

In some embodiments, the terminal device or the server may implement the interaction processing method for a virtual scene provided in the embodiments of this application by running various computer-executable instructions or a computer program. For example, the computer-executable instructions may be microprogram-level commands, machine instructions, or software instructions. The computer program may be a native program or a software module in an operating system; may be a native application (APP), namely, a program that needs to be installed in an operating system to run, such as an auto chess game APP; or may be a mini program that may be embedded in any APP, namely, a program that only needs to be downloaded into a browser environment to run. To sum up, the computer-executable instructions may be instructions in any form, and the foregoing computer program may be an application, a module, or a plug-in in any form.

For example, the computer program is an application. In actual implementation, using the terminal device 400-1 associated with Player 1 as an example, an application that supports a virtual scene may be installed and run on the terminal device 400-1. The application may be any one of a multiplayer strategy game, a virtual reality application, a three-dimensional map program, or a multiplayer shootout survival game. Player 1 may use the terminal device 400-1 to control a first virtual object in the virtual scene to perform an action. The action includes, but is not limited to, at least one of body posture adjustment, crawling, walking, running, cycling, jumping, driving, picking, shooting, attacking, throwing, and virtual building construction. Exemplarily, the first virtual object may be a virtual character, such as a simulated character or a cartoon character.

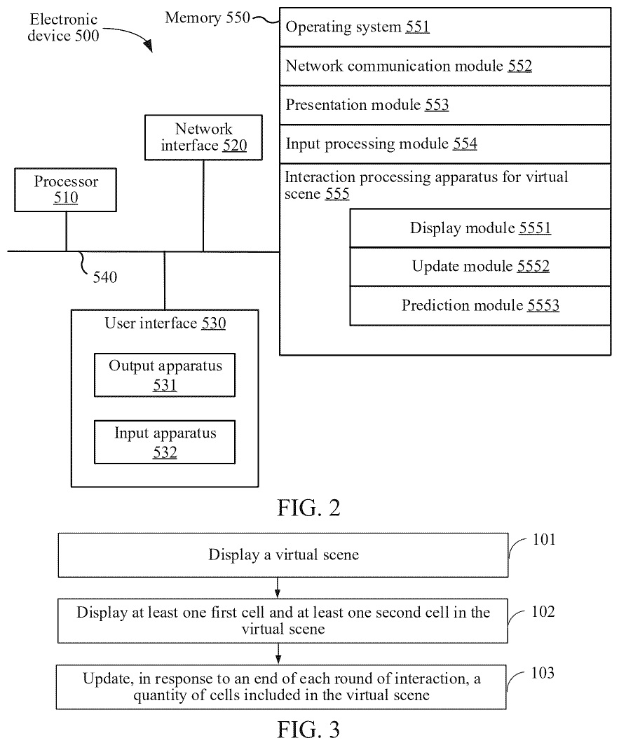

The structure of the electronic device provided in the embodiments of this application is further described below. For example, the electronic device is a terminal device. Referring to FIG. 2, FIG. 2 is a schematic structural diagram of an electronic device 500 according to an embodiment of this application. The electronic device 500 shown in FIG. 2 includes: at least one processor 510, a memory 550, at least one network interface 520, and a user interface 530. Components in the electronic device 500 are coupled together by using a bus system 540. The bus system 540 is configured to implement connection and communication between these components. In addition to a data bus, the bus system 540 further includes a power bus, a control bus, and a status signal bus. However, for ease of clear description, all types of buses are marked as the bus system 540 in FIG. 2.

The processor 510 may be an integrated circuit chip, and has a signal processing capability, for example, a general-purpose processor, a digital signal processor (DSP), another programmable logic device, a discrete gate or transistor logic device, or a discrete hardware component. The general-purpose processor may be a microprocessor or any conventional processor.

The user interface 530 includes one or more output apparatuses 531 that enable presentation of media content, including one or more speakers and/or one or more visual display screens. The user interface 530 further includes one or more input apparatuses 532, including a user interface component helping a user input, for example, a keyboard, a mouse, a microphone, a touch display screen, a camera, or another input button and control.

The memory 550 may be a removable memory, a non-removable memory, or a combination thereof. Exemplary hardware devices include a solid state memory, a hard disk drive, an optical disk drive, and the like. In some embodiments, the memory 550 includes one or more storage devices that are physically away from the processor 510.

The memory 550 includes a volatile memory or a non-volatile memory, or may include both a volatile memory and a non-volatile memory. The non-volatile memory may be a read-only memory (ROM), and the volatile memory may be a random access memory (RAM). The memory 550 described in the embodiments of this application is to include any suitable type of memories.

In some embodiments, the memory 550 can store data to support various operations. Examples of the data include a program, a module, and a data structure, or a subset or a superset thereof, which are exemplarily described below.

An operating system 551 includes system programs for processing various basic system services and performing hardware-related tasks, for example, a framework layer, a core library layer, and a driver layer for implementing various basic services and processing hardware-based tasks.

A network communication module 552 is configured to connect to other computing devices via one or more (wired or wireless) network interfaces 520. The exemplary network interfaces 520 include Bluetooth, WiFi, universal serial bus (USB), and the like.

A presentation module 553 is configured to enable presentation of information via one or more output apparatuses 531 (for example, a display and a speaker) associated with the user interface 530 (for example, a user interface for operating a peripheral device and displaying content and information).

An input processing module 554 is configured to detect one or more user inputs or interactions from one of one or more input devices 532 and translate a detected input or interaction.

In some embodiments, the apparatus provided in the embodiments of this application may be implemented by software. FIG. 2 shows an interaction processing apparatus 555 for a virtual scene stored in a memory 550, which may be software in a form of a program and a plug-in, and includes the following software modules: a display module 5551, an update module 5552, and a prediction module 5553. The modules are logical and may be combined in different manners or further split based on functions-to-be-implemented. For ease of expression, all the foregoing modules are shown at a time in FIG. 2. However, the interaction processing apparatus 555 for a virtual scene is not to be considered as excluding implementations that may include only the display module 5551 and the update module 5552. Functions of the modules are described in the following.

The interaction processing method for a virtual scene provided in the embodiments of this application is described in detail below with reference to an exemplary application and implementation of the terminal device provided in the embodiments of this application.

Referring to FIG. 3, FIG. 3 is a first schematic flowchart of an interaction processing method for a virtual scene according to an embodiment of this application. Descriptions are given below with reference to operations shown in FIG. 3.

The method shown in FIG. 3 may be performed by various forms of computer programs run by the terminal device, not limited to the client, and for example, may alternatively be the operating system, the software module, the script, and the mini program described above. Therefore, the following examples of the client are not to be considered as a limitation on the embodiments of this application. In addition, for ease of description, the terminal device and the client running on the terminal device are not specifically distinguished in the following.

Operation 101: Display a virtual scene.

Here, the virtual scene (for example, a virtual chessboard) may include a first account and a second account that participate in interaction. The first account may be Game Account 1 registered by Player 1, and the second account may be Game Account 2 registered by Player 2.

In some embodiments, using Player 1 as an example, a client (for example, an auto chess game APP) may run on a terminal device associated with Player 1, and Player 1 may log in to the client by using pre-registered Game Account 1 (that is, the first account). A matching control (for example, a matching button) may be displayed on a human-computer interaction interface of the client. When receiving a click/tap operation of Player 1 on the matching control, the client may send a matching request to a server (for example, a game backend server), so that the server performs matching. For example, the server may perform matching according to feature data (for example, credits and stats) of Game Account 1. When the matching is successful (for example, Game Account 2 registered by Player 2 is matched, where feature data of Game Account 2 is similar to feature data of Game Account 1), the client may jump to a virtual scene interface from the matching interface, so that Player 1 and Player 2 interact in the virtual scene interface.

The “feature data of Game Account 2 is similar to feature data of Game Account 1” may mean that: a difference between a win percentage of Game Account 1 and a win percentage of Game Account 2 is less than a difference threshold (that is, the win percentage of Game Account 1 and the win percentage of Game Account 2 are similar). Alternatively, a difference between credits of Game Account 1 and credits of Game Account 2 is less than a difference threshold (that is, the credits of Game Account 1 and the credits of Game Account 2 are similar). That is, skill levels of the first account and the second account that participate in the interaction are comparable, thereby avoiding poor game experience caused by an excessively large difference between skill levels of players.

In some other embodiments, the virtual scene may be displayed in the human-computer interaction interface of the client from a first-person perspective (for example, a virtual object in the game is played from a perspective of the player); or the virtual scene may be displayed from a third-person perspective (for example, the player runs after a virtual object in the game to play the game); or the virtual scene may be displayed from a bird's eye view. The foregoing different perspectives may be randomly switched.

As an example, the first virtual object may be an object controlled by a current player (for example, Player 1) in the game. Certainly, the virtual scene may further include another virtual object, for example, a virtual object that may be controlled by another player or controlled by a robot program. The first virtual object may be grouped into any one of a plurality of teams. There may be an enemy relationship or a cooperative relationship between the teams. The teams in the virtual scene may include one or both of the foregoing relationships.

Using an example in which the virtual scene is displayed from the first-person perspective, the displaying a virtual scene in a human-computer interaction interface may include: determining a field of view region of the first virtual object based on a viewing position and a field of view of the first virtual object in an entire virtual scene, and presenting a part of the virtual scene in the field of view region in the entire virtual scene, that is, the displayed virtual scene may be a part of the virtual scene relative to a panoramic virtual scene. Because the first-person perspective is a viewing perspective that can most impacts the user, immersive perception of the user being immersive in an operation process can be implemented.

Using an example in which the virtual scene is displayed from the bird's-eye view, the displaying a virtual scene in a human-computer interaction interface may include:
presenting a part of the virtual scene corresponding to a zooming operation in the human-computer interaction interface in response to the zooming operation on a panoramic virtual scene, that is, the displayed virtual scene may be a part of the virtual scene relative to the panoramic virtual scene. In this way, operability of the user during the operation process can be improved, thereby improving efficiency of human-computer interaction.

Operation 102: Display at least one first cell and at least one second cell in the virtual scene.

Here, the first cell may be configured for the first account to place at least one first virtual object (for example, chess piece), to interact (for example, battle) with at least one second virtual object placed in the second cell by the second account.

The first cell in this embodiment of this application is not a particular cell, but is a general name of cells in which the first account can place the first virtual object in the virtual scene. That is, the cells in which the first virtual objects can be placed in the virtual scene are collectively referred to as the first cells. Similarly, the second cell in this embodiment of this application is not a particular cell, but is a general name of cells in which the second account can place the second virtual object in the virtual scene. That is, the cells in which the second virtual objects can be placed in the virtual scene are generally referred to as the second cells. In addition, the first virtual object in this embodiment of this application is not a particular virtual object either, but is a general name of the virtual objects owned by the first account. That is, the virtual objects owned by the first account (for example, chess pieces bought by Player 1 from a shop control) are collectively referred to as the first virtual objects. Similarly, the second virtual object in this embodiment of this application is not a particular virtual object, but is a general name of the virtual objects owned by the second account (for example, chess pieces bought by Player 2 from the shop control). That is, the virtual objects owned by the second account may be collectively referred to as the second virtual objects.

In some embodiments, the at least one first cell may be located in a first area of the virtual scene (for example, a lower half area or a left half area of the virtual scene), and the at least one second cell may be located in a second area of the virtual scene (for example, an upper half area or a right half area of the virtual scene). The first area and the second area are two areas that are independent of each other in the virtual scene.

Exemplarily, in an example in which the at least one first cell is 5 first cells and the at least one second cell is 5 second cells, the 5 first cells may be displayed in the lower half area of the virtual scene, and the 5 second cells may be displayed in the upper half area of the virtual scene. A distribution manner of the 5 first cells in the lower half area of the virtual scene may be the same as a distribution manner of the 5 second cells in the upper half area of the virtual scene, that is, the first cells and the second cells are symmetrically distributed in the virtual scene, thereby ensuring fairness of the game. Certainly, the distribution manner of the 5 first cells (for example, cell 1 to cell 5) in the lower half area of the virtual scene may be different from the distribution manner of the 5 second cells (for example, cell 6 to cell 10) in the upper half area of the virtual scene. For example, the distribution manner of the 5 first cells in the lower half area of the virtual scene may be manually set by Player 1 (that is, the player associated with the first account), and the distribution manner of the 5 second cells in the upper half area of the virtual scene may be manually set by Player 2 (that is, the player associated with the second account). That is, a player may also manually set the distribution manner of the cells in the area of the player. This is not specifically limited in this embodiment of this application.

The cells (including the first cells and the second cells) in this embodiment of this application may be of any shape, for example, including a rectangle, a hexagon, a rhombus, a square, or an irregular shape. In addition, sizes of different cells may be the same or different. For example, the plurality of cells (including the first cells and the second cells) displayed in the virtual scene may be of the same size. Certainly, the plurality of cells displayed in the virtual scene may also be of different sizes, for example, including cells of two different sizes, namely, large cells and small cells. This is not specifically limited in this embodiment of this application.

In some other embodiments, the at least one first cell and the at least one second cell may also be distributed in the virtual scene in a staggered manner. A quantity of the first virtual objects that can be placed in each first cell is positively correlated to a size of the first cell. Similarly, a quantity of the second virtual objects that can be placed in each second cell is positively correlated to a size of the second cell.

Exemplarily, in an example in which the at least one first cell is 5 first cells (namely, cell 1 to cell 5) and the at least one second cell is 5 second cells (namely, cell 6 to cell 10), the 5 first cells and the 5 second cells may be distributed in the virtual scene in a staggered manner, and a quantity of the virtual objects (for example, chess pieces) that can be placed in each cell may be positively correlated to a size of the cell. That is, a larger size of a cell indicates a larger quantity of virtual objects that can be placed in the cell. For example, it is assumed that the size of cell 1 is 10 cm×10 cm, and the size of cell 2 is 5 cm×5 mm, and it is assumed that the size of the virtual objects is 1 cm×1 cm. Then, the quantity of the virtual objects that can be placed in cell 1 is 100, and the quantity of the virtual objects that can be placed in cell 2 is 25. Certainly, the quantity of the virtual objects that can be placed in each cell is not only positively correlated to the size of the cell, but also may be negatively correlated to the size of the virtual objects. That is, a larger size of the virtual objects indicates a smaller quantity of the virtual objects that can be placed in each cell. For example, cell 1 is taken as an example. It is assumed that the size of cell 1 is 10 cm×10 cm, and it is also assumed that the size of the virtual objects 1 is 2 cm×2 cm and the size of the virtual object 2 is 1 cm×1 cm. Then, at most 25 virtual objects 1 or at most 100 virtual objects 2 can be placed in cell 1.

The quantity of the virtual objects that can be placed in each cell may also be fixed (that is, not correlated to the size of the cell and the size of the virtual objects). For example, at most one virtual object can be placed in each cell, that is, regardless of the type of the cell, at most one virtual object (for example, chess piece) can be placed in each cell. This is not specifically limited in this embodiment of this application.

Operation 103: Update, in response to an end of each round of interaction, a quantity of cells included in the virtual scene.

In some embodiments, when the at least one first cell and the at least one second cell are respectively located in two areas that are independent of each other in a virtual scene, for example, the at least one first cell is located in a first area in the virtual scene (for example, a lower half area of the virtual scene), and the at least one second cell is located in a second area in the virtual scene (for example, an upper half area of the virtual scene), the updating a quantity of cells included in the virtual scene may be implemented in the following manner: adding at least one first cell in the first area, and adding at least one second cell in the second area.

Exemplarily, the adding at least one first cell in the first area may be implemented in the following manner: adding, in the first area, at least one first cell to at least one position adjacent to edge cells in the at least one first cell according to a fixed sequence (for example, a clockwise sequence or an anticlockwise sequence) or randomly. For example, in an example in which the first area is the lower half area of the virtual scene and the at least one first cell is 10 first cells (for example, cell 1 to cell 10), at least one first cell may be added to at least one position adjacent to edge cells in the 10 first cells in a clockwise sequence in the lower half area of the virtual scene. For example, after an end of each round of interaction, one first cell may be added to a position adjacent to edge cells in the 10 first cells in a clockwise sequence. That is, after each round of interaction ends, one first cell is added to a periphery of the 10 first cells in a clockwise sequence.

Exemplarily, the quantity of first cells added in the first area each time may be fixed or varied, and the adding at least one first cell to the first area may also be implemented in the following manner: executing one of the following processes: adding a fixed quantity (for example, 2) of the first cells in the first area, i.e., after an end of each round of interaction, a fixed quantity of the first cells is added in the first area, that is, the quantity of the first cells added each time is fixed; adding a first quantity of the first cells in the first area, the first quantity being positively correlated to a quantity of interaction rounds that have been performed currently, i.e., more rounds of interaction indicates a larger quantity of the first cells added in the first area, for example, after the first round of interaction ends, 1 first cell may be added in the first area, after the second round of interaction ends, 2 first cells may be added in the first area, and so on, i.e., the quantity of the first cells added each time may increase; adding a second quantity of the first cells in the first area, the second quantity being positively correlated to a quantity of first virtual objects placed in a preparation area of the virtual scene by the first account, i.e., a larger quantity of the first virtual objects placed in the preparation area by Player 1 indicates a larger quantity of the first cells added in the first area, for example, when the quantity of chess pieces placed in the preparation area by Player 1 is 4, 4 first cells may be added in the first area, and when the quantity of chess pieces placed in the preparation area by Player 1 is 6, 6 first cells may be added in the first area; and adding a third quantity of the first cells in the first area, the third quantity being negatively correlated to a quantity of the existing first cells in the first area, i.e., a larger quantity of the existing first cells in the first area indicates a smaller quantity of the first cells added in the first area, for example, when there are currently 10 first cells in the first area, 2 first cells may be added in the first area, and when there are currently 20 first cells in the first area, 1 first cell may be added in the first area.

In this embodiment of this application, the quantity of the cells in the virtual scene is dynamically adjusted according to the game progress. That is, the quantity of the cells in the virtual scene adapts to the game progress, and there is no unnecessary invalid cells, thereby avoiding resource waste caused by the display of unnecessary cells.

The process of adding at least one second cell in the second area is similar to the process of adding at least one first cell in the first area, and may be implemented with reference to the process of adding at least one first cell in the first area. Details are not described here again in this embodiment of this application.

In some other embodiments, for the case in which at least one first cell is located in the first area in the virtual scene and at least one second cell is located in the second area in the virtual scene, the following processes may be further executed: displaying, in response to the first account winning in the current round of interaction, at least one addition identifier (for example, “+” identifier) in the first area; and adding, in response to a selection operation on the at least one addition identifier, one first cell to a position where the selected addition identifier is located.

Exemplarily, the displaying at least one addition identifier in the first area may be implemented in the following manner: invoking, for at least one position adjacent to edge cells in the at least one first cell in the first area, a machine learning model to perform prediction processing based on feature information of the at least one first virtual object (for example, the type, the skills and the position of the virtual object) already placed in the at least one first cell, to obtain a win probability corresponding to each of the positions; and displaying at least one addition identifier at the at least one position having the win probability greater than a win probability threshold. In this way, by recommending the position in the virtual scene having a win probability greater than the win probability threshold to the player, the corresponding cell is added at the recommended position, thereby improving the win probability of the player.

For example, in an example in which the first area is the lower half area of the virtual scene and the at least one first cell is 10 first cells (assuming cell 1 to cell 10 respectively), when it is detected that the first account (for example, Game Account 1 registered by Player 1) wins in the current round of interaction, at least one position (for example, assuming position 1, position 2, position 3, and position 4) adjacent to edge cells (for example, cell 5, cell 6, and cell 8) in the 10 first cells in the lower half area of the virtual scene may be obtained. For each position, based on the types of the first virtual objects already placed in the 10 first cells by Player 1 and the positions of the first virtual objects, a trained machine learning model is invoked to perform prediction processing, to obtain a win probability corresponding to each position. For example, it is assumed that a win probability corresponding to position 1 is 90%, a win probability corresponding to position 2 is 95%, a win probability corresponding to position 3 is 86%, and a win probability corresponding to position 4 is 84%. Then, an addition identifier may be displayed at the position (i.e., position 2) having the win probability greater than a win probability threshold (for example, 90%). After a click/tap operation performed by Player 1 on the addition identifier displayed at position 2 is received, one first cell (for example, cell 11) may be added to position 2, so as to increase a win probability of the player in subsequent interaction, thereby improving game experience of the player.

In some other embodiments, continuing with the foregoing example, before the machine learning model is invoked to perform prediction processing, the following processes may be further executed: obtaining interaction data of a sample winner account and a sample loser account, the interaction data including positions of virtual objects controlled by the sample loser account in the virtual scene (i.e., distribution of the virtual objects in the virtual scene) and positions of virtual objects controlled by the sample winner account in the virtual scene; invoking, based on the interaction data, an initialized machine learning model to perform prediction processing, to obtain a prediction result; and determining a difference between the prediction result and marked data, performing back propagation based on the difference, and updating parameters of the machine learning model layer by layer during the back propagation, the marked data including positions of virtual objects controlled by the sample winner account in the virtual scene.

Exemplarily, an exemplary structure of the machine learning model may include: an input layer (i.e., an embedding layer), an encoding layer (which may be for example formed by a plurality of cascaded convolutional layers), a fully connected layer, and an output layer (including an activation function such as a Softmax function). After the interaction data of the sample winner account and the sample loser account is obtained, the interaction data may be first inputted into the input layer for embedding process. Then, encoding processing may be performed, through the encoding layer, on an embedding feature vector outputted by the input layer, to obtain a hidden layer feature vector. Subsequently, the hidden layer feature vector may be fully connected through the fully connected layer. Finally, a full connection result outputted by the fully connected layer may be inputted into the output layer, to perform activation processing through the output layer, so as to obtain a prediction result. After the prediction result is obtained, the prediction result and the marked data may be substituted into a loss function, to obtain a corresponding difference, and back propagation may be performed based on the difference, so that the parameters of the machine learning model can be updated layer by layer during the back propagation, thereby obtaining the trained machine learning model.

The following describes the principle of the foregoing back propagation. Training sample data is inputted into an input layer of a machine learning model, passes through a hidden layer, and finally reaches an output layer and a result is outputted. This is a forward propagation process of the machine learning model. Because there is an error between the output result of an initialized machine learning model and the actual result, the error between the output result and the actual value is calculated, and the error is backpropagated from the output layer to the hidden layer until the error is propagated to the input layer. In the backpropagation process, values of parameters of the machine learning model are adjusted according to the error. That is, a loss function is constructed according to the error between the output result and the actual value, and a partial derivative of the loss function for the model parameters is obtained layer by layer, and a gradient of the loss function for the model parameters of each layer is generated. Because a direction of the gradient indicates a direction of error expansion, the gradient of the model parameters is inverted, the original parameters of the model of each layer are summed therewith, and the obtained summation result is used as the updated parameters of the model of each layer, thereby reducing the error caused by the model parameters. The foregoing process is continuously iterated until convergence occurs.

The machine learning model may be a neural network model (for example, a convolutional neural network, a deep convolutional neural network, or a fully connected neural network), a decision tree model, a gradient lifting tree, a multi-layer perceptron, a support vector machine, and the like. The type of the machine learning model is not specifically limited in this embodiment of this application.

In some embodiments, a display style (for example, including color, size, and the like) of the newly added cells (including the first cells and the second cells) in the virtual scene may be different from a display style of the existing cells in the virtual scene, and when a next round of interaction starts, the display style of the newly added cells is adjusted to be the same as the display style of the existing cells. For example, the color of the newly added cells may be restored to be the same as the color of the existing cells. In this way, it may be convenient for the player to learn which cells are the newly added cells in the virtual scene after the interaction ends.

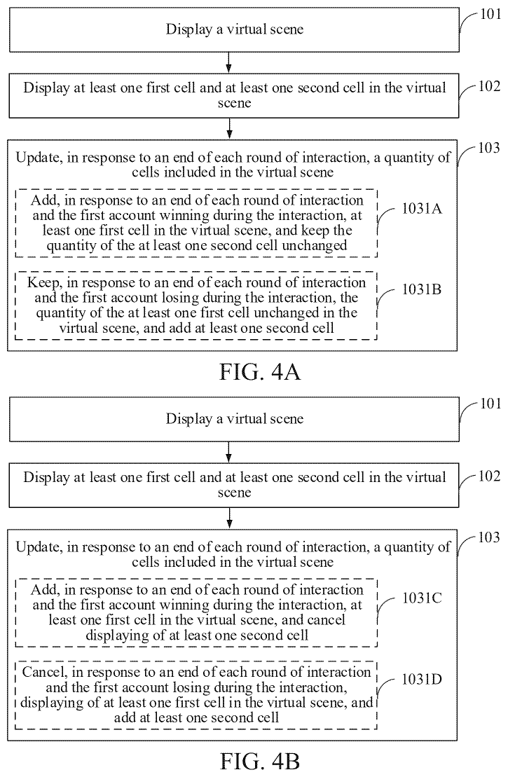

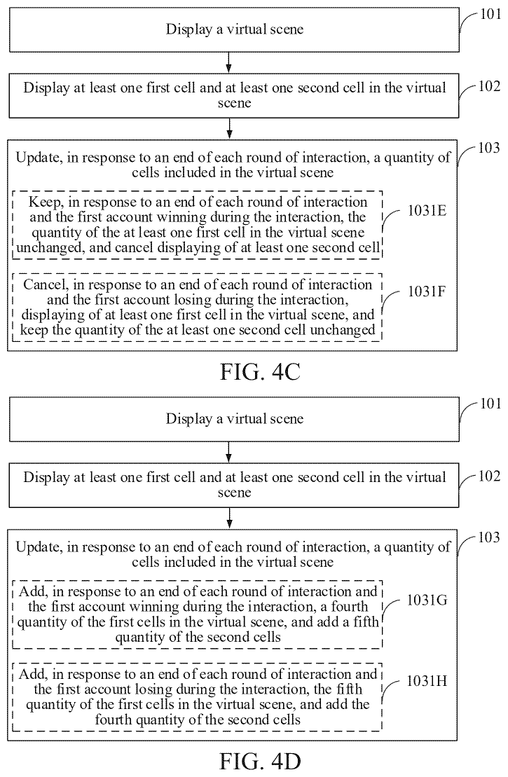

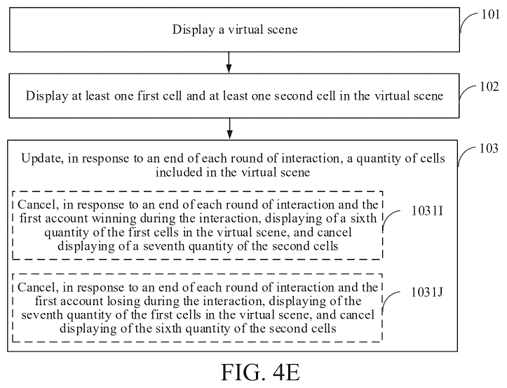

In some other embodiments, in this embodiment of this application, only the cell corresponding to the winner account may be added while the quantity of cells corresponding to the loser account is kept unchanged. Referring to FIG. 4A, FIG. 4A is a second schematic flowchart of an interaction processing method for a virtual scene according to an embodiment of this application. As shown in FIG. 4A, operation 103 shown in FIG. 3 may be implemented through operation 1031A or operation 1031B shown in FIG. 4A. Descriptions are given below with reference to operations shown in FIG. 4A.

Operation 1031A: Add, in response to an end of each round of interaction and the first account winning during the interaction, at least one first cell in the virtual scene, and keep the quantity of the at least one second cell unchanged.

In some embodiments, the adding at least one first cell in the virtual scene may be implemented in the following manner: adding, in response to a position selection operation, at least one first cell to at least one selected position in the virtual scene; or adding at least one first cell to at least one randomly selected position in the virtual scene.

Exemplarily, in an example in which the first account is Game Account 1 registered by Player 1, when the client detects that Player 1 wins in the current round of interaction, for example, detects that the first virtual objects controlled by Player 1 defeat the second virtual objects controlled by Player 2 in the current round of interaction, first prompt information may be displayed. The first prompt information is configured for prompting Player 1 to add one first cell at a position selected by Player 1. Next, in response to a position selection operation triggered by Player 1 in the virtual scene, the client adds one first cell at the position (for example, position 1) selected by Player 1 in the virtual scene. Certainly, when the client detects that Player 1 wins in the current round of interaction, the first cell may also be randomly added to any position in the virtual scene. This is not specifically limited in this embodiment of this application.

Operation 1031B: Keep, in response to an end of each round of interaction and the first account losing during the interaction, the quantity of the at least one first cell unchanged in the virtual scene, and add at least one second cell.

In some embodiments, in an example in which the first account is Game Account 1 registered by Player 1, when the client detects that Player 1 loses in the current round of interaction, for example, detects that the first virtual objects controlled by Player 1 are defeated by the second virtual objects controlled by Player 2 in the current round of interaction, the quantity of the at least one first cell may be kept unchanged in a first area of the virtual scene (that is, an area corresponding to the first account in the virtual scene, for example, the lower half area of the virtual scene), and at least one second cell may be added in a second area of the virtual scene (that is, an area corresponding to the second account in the virtual scene, for example, the upper half area of the virtual scene). That is, the quantity of cells of the loser does not change, and one cell may be added for the winner, so as to motivate the players to participate in the battle more actively.

In some embodiments, in this embodiment of this application, the cell corresponding to the winner account may be added while the cell corresponding to the loser account is reduced. Referring to FIG. 4B, FIG. 4B is a third schematic flowchart of an interaction processing method for a virtual scene according to an embodiment of this application. As shown in FIG. 4B, operation 103 shown in FIG. 3 may be implemented through operation 1031C or operation 1031D shown in FIG. 4B. Descriptions are given below with reference to operations shown in FIG. 4B.

Operation 1031C: Add, in response to an end of each round of interaction and the first account winning during the interaction, at least one first cell in the virtual scene, and cancel displaying of at least one second cell.

In some embodiments, in an example in which the first account is Game Account 1 registered by Player 1, when the client detects that Player 1 wins in the current round of interaction, the client may add one first cell in a first area of the virtual scene (that is, an area corresponding to the first account in the virtual scene, for example, the lower half area of the virtual scene), for example, add one first cell at a position adjacent to the existing at least one first cell, and cancel displaying of at least one second cell in a second area of the virtual scene (that is, an area corresponding to the second account in the virtual scene, for example, the upper half area of the virtual scene). For example, assuming that there are originally 10 second cells (for example, assuming to be cell 1 to cell 10) in the second area, displaying of one second cell (for example, cell 3) may be randomly canceled from the 10 second cells. Certainly, displaying of a cell selected by Player 1 may also be canceled from the 10 second cells. That is, when Player 1 wins in the current round of interaction, Player 1 may select one cell from the 10 second cells corresponding to Player 2 for cancellation. For example, assuming that Player 1 selects cell 4 from the 10 second cells, displaying of cell 4 may be canceled in the second area of the virtual scene.

The second cell whose displaying is to be canceled may alternatively be selected by Player 2. For example, when the client detects that Player 2 loses in the current round of interaction, prompt information may be displayed to prompt Player 2 that Player 2 needs to select a cell for cancellation. Assuming that Player 2 selects cell 5 from the 10 second cells, displaying of cell 5 selected by Player 2 may be canceled in the second area of the virtual scene.

That is, the at least one second cell whose displaying is to be canceled may be selected by either the winner or the loser in the current round of interaction. This is not specifically limited in this embodiment of this application.

Operation 1031D: Cancel, in response to an end of each round of interaction and the first account losing during the interaction, displaying of at least one first cell in the virtual scene, and add at least one second cell.

In some embodiments, the canceling displaying of at least one first cell in the virtual scene may be implemented in the following manner: canceling, in response to a selection operation on the at least one first cell, displaying of at least one selected first cell in the virtual scene; and or randomly canceling displaying of at least one first cell from the at least one first cell.

Exemplarily, in an example in which the first account is Game Account 1 registered by Player 1, when the client detects that Player 1 loses in the current round of interaction, for example, the first virtual objects controlled by Player 1 are defeated by the second virtual objects controlled by Player 2 in the current round of interaction, second prompt information may be displayed. The second prompt information is configured for prompting Player 1 to delete a cell. For example, the client may delete a first cell selected by Player 1 from the at least one first cell from the first area, or delete a first cell selected by Player 2 from the at least one first cell from the first area. Certainly, when the client detects that Player 1 loses in the current round of interaction, the client may also randomly cancel displaying one first cell from the at least one first cell. This is not specifically limited in this embodiment of this application. In this way, by adding the cell of the winner and reducing the cell of the loser, the players can be motivated and get more actively involved in the game.

In some other embodiments, in this embodiment of this application, the quantity of cells corresponding to the winner account may be kept unchanged while the quantity of cells corresponding to the loser account is reduced. Referring to FIG. 4C, FIG. 4C is a fourth schematic flowchart of an interaction processing method for a virtual scene according to an embodiment of this application. As shown in FIG. 4C, operation 103 shown in FIG. 3 may be implemented through operation 1031E or operation 1031F shown in FIG. 4C. Descriptions are given below with reference to operations shown in FIG. 4C.

Operation 1031E: Keep, in response to an end of each round of interaction and the first account winning during the interaction, the quantity of the at least one first cell in the virtual scene unchanged, and cancel displaying of at least one second cell.

In some embodiments, in an example in which the first account is Game Account 1 registered by Player 1, when the client detects that Player 1 wins in the current round of interaction, the client may keep the quantity of the at least one first cell unchanged in a first area of the virtual scene (that is, an area corresponding to Player 1 in the virtual scene, for example, the lower half area of the virtual scene), and cancel displaying of at least one second cell in a second area of the virtual scene (that is, an area corresponding to Player 2 interacting with Player 1 in the virtual scene, for example, the upper half area of the virtual scene). For example, the client may delete a second cell selected by Player 2 from the at least one second cell (that is, delete a cell selected by the loser from the area of the loser). Alternatively, the client may delete a second cell selected by Player 1 from the at least one second cell (that is, delete a cell selected by the winner from the area corresponding to the loser). Alternatively, the client may randomly delete a second cell from the at least one second cell. This is not specifically limited in this embodiment of this application.

Operation 1031F: Cancel, in response to an end of each round of interaction and the first account losing during the interaction, displaying of at least one first cell in the virtual scene, and keep the quantity of the at least one second cell unchanged.

In some embodiments, still in the example in which the first account is Game Account 1 registered by Player 1, when the client detects that Player 1 loses in the current round of interaction, for example, the first virtual objects controlled by Player 1 are defeated by the second virtual objects controlled by Player 2 in the current round of interaction, the client may cancel displaying of at least one first cell in the first area of the virtual scene, for example, delete a first cell selected by Player 1 from the at least one first cell displayed in the first area, or delete a first cell selected by Player 2 from the at least one first cell displayed in the first area, or randomly delete a first cell from the at least one first cell displayed in the first area, and keep the quantity of the at least one second cell unchanged in the second area of the virtual scene. That is, in this embodiment of this application, the quantity of cells of the winner may be kept unchanged, and the quantity of cells of the loser may be reduced, so as to motivate the players, thereby improving enthusiasm and game experience of the players.

In some embodiments, in this embodiment of this application, the quantities of cells respectively corresponding to both the winner account and the loser account may be increased while the quantity of cells increased for the winner account is greater than the quantity of cells increased for the loser account. Referring to FIG. 4D, FIG. 4D is a fifth schematic flowchart of an interaction processing method for a virtual scene according to an embodiment of this application. As shown in FIG. 4D, operation 103 shown in FIG. 3 may be implemented through operation 1031G or operation 1031H shown in FIG. 4D. Descriptions are given below with reference to operations shown in FIG. 4D.

Operation 1031G: Add, in response to an end of each round of interaction and the first account winning during the interaction, a fourth quantity of the first cells in the virtual scene, and add a fifth quantity of the second cells.

Here, the fourth quantity may be greater than the fifth quantity.

In some embodiments, in an example in which the first account is Game Account 1 controlled by Player 1, when the client detects that Player 1 wins in the current round of interaction, the client may add a fourth quantity of the first cells in a first area of the virtual scene (that is, an area corresponding to Player 1 in the virtual scene, for example, the lower half area of the virtual scene), and add a fifth quantity of the second cells in a second area of the virtual scene (for example, an area corresponding to Player 2 in the virtual scene, for example, the upper half area of the virtual scene). For example, the client may add 2 first cells in the lower half area of the virtual scene, and add 1 second cell in the upper half area of the virtual scene. That is, 2 available cells are added for Player 1, but only 1 available cell is added for Player 2.

Operation 1031H: Add, in response to an end of each round of interaction and the first account losing during the interaction, the fifth quantity of the first cells in the virtual scene, and add the fourth quantity of the second cells.

In some embodiments, still in the example in which the first account is Game Account 1 registered by Player 1, when the client detects that Player 1 loses in the current round of interaction, for example, the first virtual objects placed in the first cells by Player 1 are defeated by the second virtual objects placed in the second cells by Player 2, the client may add a fifth quantity of the first cells in a first area of the virtual scene, and add a fourth quantity of the second cells in a second area of the virtual scene. For example, in an example in which the first area is the lower half area of the virtual scene and the second area is the upper half area of the virtual scene, 1 first cell may be added in the lower half area of the virtual scene, and 2 second cells may be added in the upper half area of the virtual scene. That is, 2 available cells are added for the winner Player 2, but only 1 available cell is added for the loser Player 1. In this way, the players can be motivated, so that the players can get involved in the game more actively, thereby improving game experience of the players.

In some other embodiments, in this embodiment of this application, the quantities of cells respectively corresponding to both the winner account and the loser account may be reduced while the quantity of cells reduced for the winner account is less than the quantity of cells reduced for the loser account. Referring to FIG. 4E, FIG. 4E is a sixth schematic flowchart of an interaction processing method for a virtual scene according to an embodiment of this application. As shown in FIG. 4E, operation 103 shown in FIG. 3 may be implemented through operation 1031I and operation 1031J shown in FIG. 4E. Descriptions are given below with reference to operations shown in FIG. 4E.

Operation 1031I: Cancel, in response to an end of each round of interaction and the first account winning during the interaction, displaying of a sixth quantity of the first cells in the virtual scene, and cancel displaying of a seventh quantity of the second cells.

Here, the sixth quantity may be less than the seventh quantity.

In some embodiments, in an example in which the first account is Game Account 1 registered by Player 1, when the client detects that Player 1 wins in the current round of interaction, for example, the first virtual objects placed in the first cells by Player 1 defeat the second virtual object placed in the second cell by Player 2 in the current round of interaction, the client may delete a sixth quantity of the first cells from the at least one first cell (for example, 10 first cells) displayed in the first area of the virtual scene, and delete a seventh quantity of the second cells from the at least one second cell (for example, 8 second cells) displayed in the second area of the virtual scene. For example, assuming that 10 first cells are displayed in the lower half area of the virtual scene and 8 second cells are displayed in the upper half of the virtual scene, when the client detects that Player 1 wins in the current round of interaction, the client may delete 1 first cell (for example, the first cell selected by Player 1, or the first cell randomly selected by the client from the 10 first cells) from the 10 first cells, and delete 2 second cells (for example, 2 second cells selected by Player 2 from the 8 second cells, or 2 second cells randomly selected by the client from the 8 second cells) from the 8 second cells.

Operation 1031J: Cancel, in response to an end of each round of interaction and the first account losing during the interaction, displaying of the seventh quantity of the first cells in the virtual scene, and cancel displaying of the sixth quantity of the second cells.

In some embodiments, still in the example in which the first account is Game Account 1 registered by Player 1, when the client detects that Player 1 loses in the current round of interaction, for example, the first virtual objects (for example, chess pieces) placed in the first cells by Player 1 are defeated by the second virtual objects placed in the second cells by Player 2 in the current round of interaction, the client may delete the seventh quantity of the first cells from the at least one first cell (for example, 10 first cells) displayed in the first area of the virtual scene, and delete the sixth quantity of the second cells from the at least one second cell (for example, 8 second cells) displayed in the second area of the virtual scene. For example, in an example in which the first area is the lower half area of the virtual scene and the second area is the upper half area of the virtual scene, 10 first cells are displayed in the lower half area of the virtual scene, and 8 second cells are displayed in the upper half area of the virtual scene. When it is detected that Player 1 loses in the current round of interaction, 2 first cells (for example, 2 first cells selected from the 10 first cells by Player 1, or 2 first cells randomly selected from the 10 first cells by the client) may be deleted from the 10 first cells, and 1 second cell may be deleted from the 8 second cells. For example, 1 second cell selected from the 8 second cells by Player 2 may be deleted, or 1 second cell may be randomly deleted from the 8 second cells by the client. This is not specifically limited in this embodiment of this application.

The embodiments of this application provide a brand new interaction manner in a virtual scene. After the end of each round of interaction, the quantity of cells in the virtual scene is controlled to change. That is, in the technical solutions provided in the embodiments of this application, the quantity of cells in the virtual scene is not fixed, but continuously changes as the game progresses. In this way, compared with the mode of a fixed quantity of cells provided in the related technology, in the technical solutions provided in the embodiments of this application, the quantity of cells in the virtual scene adapts to the game progress, so that there are no unnecessary invalid cells, thereby avoiding resource waste caused by the display of unnecessary cells.

The following uses an auto chess game as an example to describe an exemplary application of the embodiments of this application in an actual application scenario.

A chessboard of auto chess games provided in the related technology usually has a fixed structure, that is, the quantity of tiles is fixed, and a player places chess pieces to battle on corresponding tiles (corresponding to the foregoing cells). That is, in the solution provided in the related technology, there is only a manner in which a player interacts with chess pieces on a known chessboard, and the player can only place chess pieces on tiles with buff during a preparation period to trigger corresponding buffs. However, fixed tiles have some limitations to expansion of gameplay. That is, the gameplay is limited to arrangement of positions, and there is no other tactical gameplay. Consequently, the player is prone to be bored. In addition, because the quantity of tiles is fixed in the game process, unnecessary invalid tiles may exist at some stages, resulting in resource waste.

In view of this, an embodiment of this application provides an interaction processing method for a virtual scene. By breaking down the chessboard modality, through interesting gameplay that enlarges the chessboard area by battling, the original fixed chessboard mode is broken by the gameplay, allowing players to have more tactical gameplay options and increasing the possibility of the chessboard as a gameplay carrier. That is, this embodiment of this application provides a manner of modally breaking down a chessboard, to set a brand new gameplay starting from the chessboard itself, thereby increasing the possibility of the chessboard as a gameplay carrier, and bringing a brand new point of interest for game tactics to the players. In addition, in this embodiment of this application, the quantity of tiles included in the chessboard is dynamically adjusted according to the game progress, so as to avoid resource waste caused by displaying of unnecessary tiles.

The interaction processing method for a virtual scene according to the embodiments of this application is further described in detail below.

In some embodiments, there are only some tiles in battle areas of two players at the beginning, and the players can only place chess pieces in these tiles to battle.

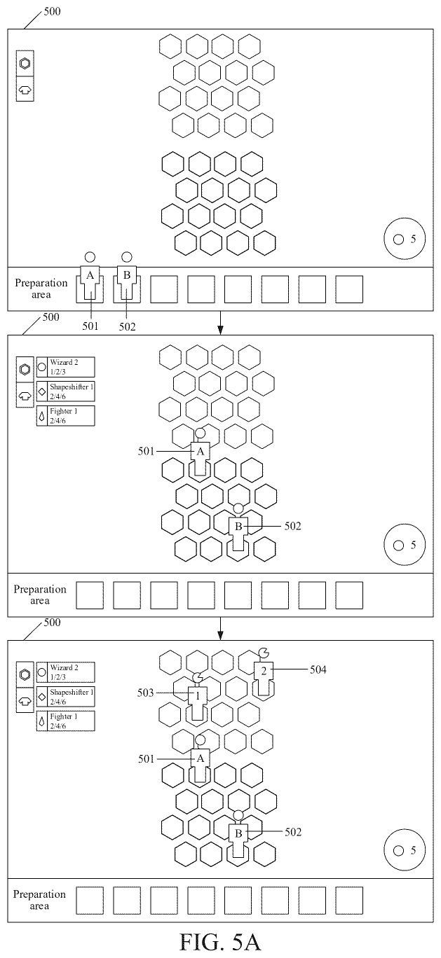

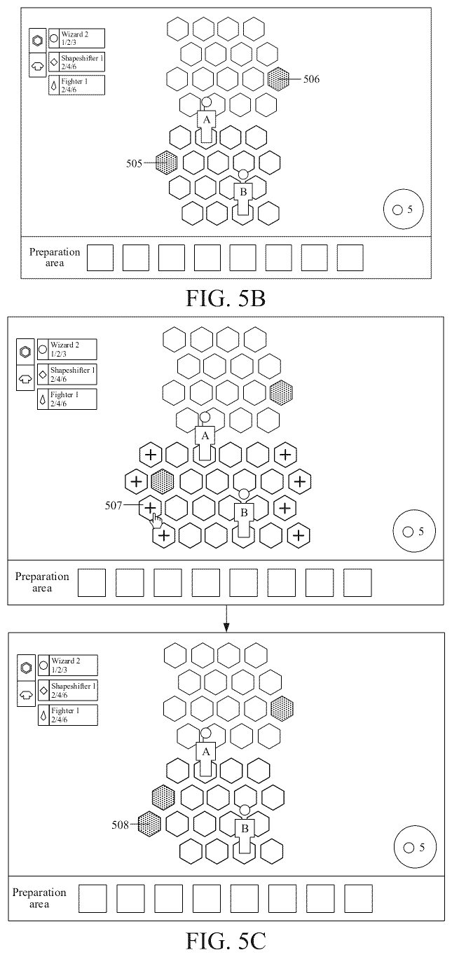

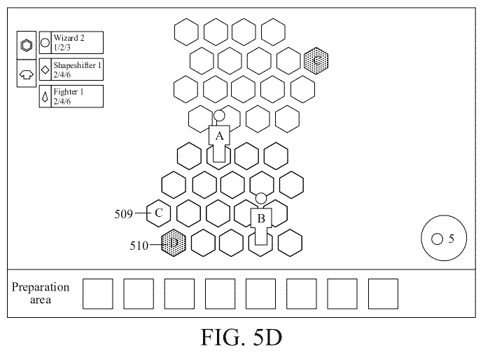

Exemplarily, referring to FIG. 5A, FIG. 5A is a schematic diagram of a first application scenario of an interaction processing method for a virtual scene according to an embodiment of this application. As shown in FIG. 5A, a virtual chessboard 500 includes a preparation area and a battle area. The battle area may be divided into upper and lower parts (for example, the lower half part corresponds to Player 1, corresponding to a first area, and the upper half part corresponds to Player 2, corresponding to a second area), and a set quantity of tiles are respectively displayed in the two parts. Player 1 may place chess pieces (for example, including chess piece 501 and chess piece 502) in the preparation area into the tiles (corresponding to the first cells) in the lower half part, to battle with chess pieces (for example, including chess piece 503 and chess piece 504) placed in the tiles (corresponding to the second cells) of the upper half part by Player 2.

In some embodiments, the quantity of tiles on the field is continuously increased according to the round of battle. After an end of each round of battle, N (where N is a configurable quantity) edge tiles may be added. For example, 1 tile may be added for each round. Positions of the tiles may be set according to a fixed sequence or randomly in edge areas, and a newly added tile can only fill a position adjacent to the existing tiles. This is because a chess piece in an auto chess game cannot move across empty tiles, and the tiles need to be connected. In addition, the newly added tile may show a color distinguished from that of the other tiles (that is, the existing tiles), and restore to a default tile color after a next round of battle starts. For example, the newly added tile restores from yellow to gray.

Exemplarily, referring to FIG. 5B, FIG. 5B is a schematic diagram of a second application scenario of an interaction processing method for a virtual scene according to an embodiment of this application. As shown in FIG. 5B, after an end of each round of battle, one tile may be added to an edge position of each of the upper part and the lower part. For example, a tile 505 may be added to an edge position of the lower half part and a tile 506 may be added to an edge position of the upper half part. That is, one tile is added for each of Player 1 and Player 2. In addition, the color of the newly added tile 505 and tile 506 may be different from that of the existing tiles. For example, the newly added tile 505 and tile 506 are yellow and the existing tiles are gray. In this way, the players can intuitively learn which tiles are newly added currently.

In some embodiments, after winning, the player may obtain an additional tile expansion opportunity. The position of the tile may be determined by the player. The position of the tile also follows the principle of adjacency. The client displays a “+” sign (corresponding to the foregoing addition identifier) at a position at which the tile may be added. The player clicks/taps the “+” sign at the position to be added, to add the tile. The newly added tile also shows the color of new tiles, and restores to the default tile color after the battle starts.

Exemplarily, referring to FIG. 5C, FIG. 5C is a schematic diagram of a third application scenario of an interaction processing method for a virtual scene according to an embodiment of this application. As shown in FIG. 5C, after the client determines that Player 1 wins in the battle, a plurality of “+” signs may be displayed, in the lower half part, at a plurality of positions at which tiles may be added. Player 1 may select among the plurality of “+” signs. When a click/tap operation performed by Player 1 on a “+” sign 507 among the plurality of “+” signs is received, a tile 508 may be added at the position of the “+” sign 507. The color of the newly added tile 508 is different from the color of the plurality of existing tiles in the lower half part.

In some embodiments, if a current default filling logic is sequential filling, when the client is to fill the position in sequence and finds that there is a tile added by the player at this position, this position is skipped, and the next position is filled. For example, referring to FIG. 5D, FIG. 5D is a schematic diagram of a fourth application scenario of an interaction processing method for a virtual scene according to an embodiment of this application. As shown in FIG. 5D, originally, position 509 (for example, position C) is to be filled by both players in this round, but Player 1 has filled position 509 when winning in the last round, so the next position 510 (for example, position D) may be subsequently filled.

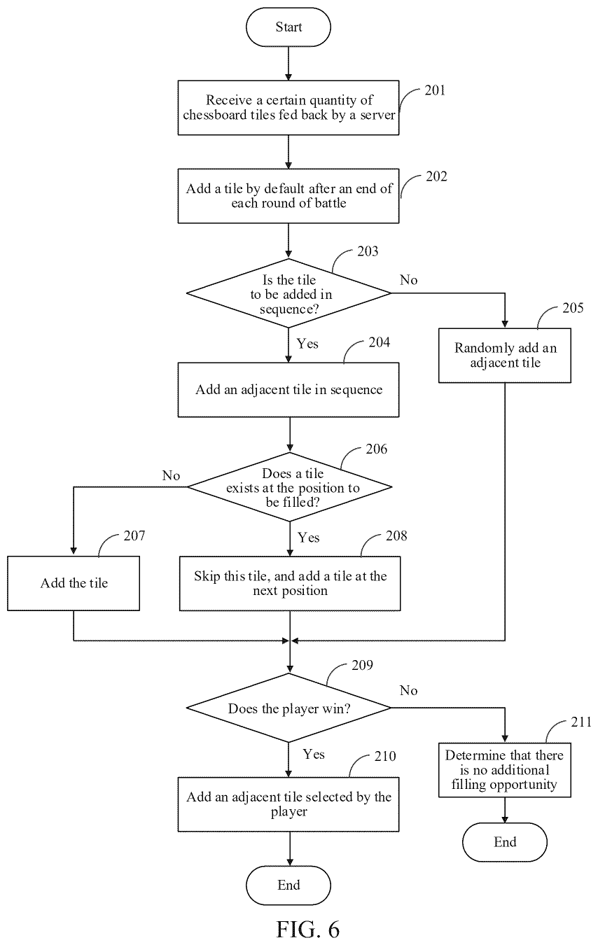

The interaction processing method for a virtual scene provided in the embodiments of this application is further described in detail below with reference to FIG. 6.

Exemplarily, referring to FIG. 6, FIG. 6 is a seventh schematic flowchart of an interaction processing method for a virtual scene according to an embodiment of this application. Descriptions are given below with reference to operations shown in FIG. 6.

Operation 201: Receive a certain quantity of chessboard tiles fed back by a server.

In some embodiments, the server may send a set quantity of tiles to the client, so that the client displays a corresponding quantity of tiles in the chessboard. A player may place chess pieces in this quantity of tiles. For example, it may be determined whether the chess piece placed by the player is in a set area, and if so, the chess piece is placed successfully, or if not, it is determined that the chess piece is placed unsuccessfully, and a corresponding prompt message (Tips) is displayed, to prompt the player to “Only place in the chessboard area”.

Operation 202: Add a tile by default after an end of each round of battle.

Operation 203: Determine whether to add the tile in sequence, and if so, execute operation 204, or if not, execute operation 205.

Operation 204: Add an adjacent tile in sequence.

Operation 205: Randomly add an adjacent tile.

Operation 206: Determine whether a tile exists at the position to be filled, and if not, execute operation 207, or if so, execute operation 208.

Operation 207: Add the tile.

Operation 208: Skip this tile, and add a tile at the next position.

In some embodiments, after each round of battle ends, a quantity of tiles are added, and the added tiles can only be adjacent to the existing tiles. Before the addition, whether the tiles are to be sequentially added or randomly added may be determined. For the sequential addition, a corresponding quantity of tiles are sequentially added in sequence in each round, and if the current tile already exists, this tile is skipped, and a tile at a next position in sequence is added. For the random addition, a quantity of random adjacent tiles are added, and if the current tile already exists, the tile is randomly added to another position.

Operation 209: Determine whether the player wins, and if so, execute operation 210, or if not, execute operation 211.

Operation 210: Add an adjacent tile selected by the player.

Operation 211: Determine that there is no additional filling opportunity.

In some embodiments, the client may further determine whether the player wins. If the player wins, the client sends a win message to the server, and the server may return a status of adding a tile to the client. In this case, the chessboard shows a “+” sign identifier for allowing addition of a tile, and the player may add a tile at the corresponding position by clicking/tapping the “+” sign. If the player loses, only the tile to be automatically added by the system is added, and there is no additional opportunity to add a tile.

Based on the above, the technical solutions provided in the embodiments of this application have the following beneficial effects:

This embodiment of this application is intended to break the setting of a chessboard having a fixed quantity of tiles, and provide a new gameplay mode based on the chessboard as a carrier. When there are a small quantity of tiles, the player needs to focus on the arrangement of positions of chess pieces. As the quantity of tiles increases, there are more possibilities for the positions of the chess pieces. The player may select the position where the tile is to be added according to the front row or the back row, to generate more abundant and variable formations, thereby adding fun to the game. In addition, in the embodiments of this application, the quantity of tiles included in the chessboard is dynamically adjusted according to the game progress. Compared with the mode of a fixed quantity of tiles provided in the related technology, resource waste caused by displaying of unnecessary tiles can be avoided.

The following further illustrates an exemplary structure in which the interaction processing apparatus 555 for a virtual scene provided in the embodiments of this application is implemented as software modules. In some embodiments, as shown in FIG. 2, the software modules of the interaction processing apparatus 555 for a virtual scene stored in the memory 550 may include: a display module 5551 and an update module 5552.

The display module 5551 is configured to display a virtual scene, the virtual scene including a first account and a second account that participate in interaction. The display module 5551 is further configured to display at least one first cell and at least one second cell in the virtual scene. The first cell is configured for the first account to place at least one first virtual object, to interact with at least one second virtual object placed in the second cell by the second account. The update module 5552 is configured to update, in response to an end of each round of interaction, a quantity of cells included in the virtual scene.

In some embodiments, the at least one first cell is located in a first area of the virtual scene, and the at least one second cell is located in a second area of the virtual scene. The first area and the second area are two areas that are independent of each other in the virtual scene. The update module 5552 is further configured to add at least one first cell in the first area, and add at least one second cell in the second area.

In some embodiments, the update module 5552 is further configured to add, in the first area, at least one first cell to at least one position adjacent to edge cells in the at least one first cell according to a fixed sequence or randomly.

In some embodiments, the update module 5552 is further configured to perform one of the following processes: adding a fixed quantity of the first cells in the first area; adding a first quantity of the first cells in the first area, the first quantity being positively correlated to a quantity of interaction rounds that have been performed currently; adding a second quantity of the first cells in the first area, the second quantity being positively correlated to a quantity of first virtual objects placed in a preparation area of the virtual scene by the first account; and adding a third quantity of the first cells in the first area, the third quantity being negatively correlated to a quantity of the existing first cells in the first area.

In some embodiments, the display module 5551 is further configured to display, in response to the first account winning in the current round of interaction, at least one addition identifier in the first area. The update module 5552 is further configured to add, in response to a selection operation on the at least one addition identifier, one first cell to a position where the selected addition identifier is located.

In some embodiments, the interaction processing apparatus 555 for a virtual scene further includes a prediction module 5553, configured to invoke, for at least one position adjacent to edge cells in the at least one first cell in the first area, a machine learning model to perform prediction processing based on feature information of the at least one first virtual object already placed in the at least one first cell, to obtain a win probability corresponding to each of the positions. The display module 5551 is further configured to display at least one addition identifier at the at least one position having the win probability greater than a win probability threshold.

In some embodiments, a display style of the newly added cells in the virtual scene is different from a display style of the existing cells in the virtual scene, and when a next round of interaction starts, the display style of the newly added cells is adjusted to be the same as the display style of the existing cells.

In some embodiments, the update module 5552 is further configured to add, in response to the first account winning in the current round of interaction, at least one first cell in the virtual scene, and keep a quantity of the at least one second cell unchanged; and configured to keep, in response to the first account losing in the current round of interaction, the quantity of the at least one first cell unchanged in the virtual scene, and add at least one second cell.

In some embodiments, the update module 5552 is further configured to add, in response to a position selection operation, at least one first cell to at least one selected position in the virtual scene; or configured to add at least one first cell to at least one randomly selected position in the virtual scene.

In some embodiments, the update module 5552 is further configured to add, in response to the first account winning in the current round of interaction, at least one first cell in the virtual scene, and cancel displaying of at least one second cell; and configured to cancel, in response to the first account losing in the current round of interaction, displaying of at least one first cell in the virtual scene, and add at least one second cell.

In some embodiments, the update module 5552 is further configured to cancel, in response to a selection operation on the at least one first cell, displaying of at least one selected first cell in the virtual scene; or configured to randomly cancel displaying of at least one first cell from the at least one first cell.

In some embodiments, the update module 5552 is further configured to keep, in response to the first account winning in the current round of interaction, the quantity of the at least one first cell unchanged in the virtual scene, and configured to cancel displaying of at least one second cell; and cancel, in response to the first account losing in the current round of interaction, displaying of at least one first cell in the virtual scene, and keep a quantity of the at least one second cell unchanged.

In some embodiments, the update module 5552 is further configured to add, in response to the first account winning in the current round of interaction, a fourth quantity of the first cells in the virtual scene, and add a fifth quantity of the second cells; and configured to add, in response to the first account losing in the current round of interaction, the fifth quantity of the first cells in the virtual scene, and add the fourth quantity of the second cells. The fourth quantity is greater than the fifth quantity.

In some embodiments, the update module 5552 is further configured to cancel, in response to the first account winning in the current round of interaction, displaying of a sixth quantity of the first cells in the virtual scene, and cancel displaying of a seventh quantity of the second cells; and configured to cancel, in response to the first account losing in the current round of interaction, displaying of the seventh quantity of the first cells in the virtual scene, and cancel displaying of the sixth quantity of the second cells. The sixth quantity is less than the seventh quantity.

In some embodiments, the at least one first cell and the at least one second cell are distributed in the virtual scene in a staggered manner. The quantity of the first virtual objects that can be placed in each first cell is positively correlated to a size of the first cell, and the quantity of the second virtual objects that can be placed in each second cell is positively correlated to a size of the second cell.

Descriptions of the apparatus embodiments are similar to the descriptions of the foregoing method embodiments. The apparatus embodiments have beneficial effects similar to those of the method embodiments and thus are not repeatedly described. Technical details that are not completed in the interaction processing apparatus for a virtual scene provided in this embodiment of this application may be understood according to descriptions in any one of FIG. 3 or FIG. 4A to FIG. 4E.

An embodiment of this application provides a computer program product. The computer program product includes a computer program or a computer-executable instruction. The computer program or the computer-executable instruction is stored in a non-transitory computer-readable storage medium. A processor of a computer device reads the computer-executable instruction from the computer-readable storage medium, and executes the computer-executable instruction, to cause the computer device to perform the interaction processing method for a virtual scene in the embodiments of this application.

An embodiment of this application provides a non-transitory computer-readable storage medium having a computer-executable instruction stored therein. The computer-executable instruction, when executed by a processor, causes the processor to perform the interaction processing method for a virtual scene provided in the embodiments of this application, for example, the interaction processing method for a virtual scene shown in any one of FIG. 3 or FIG. 4A to FIG. 4E.

In some embodiments, the computer-readable storage medium may be a memory such as a ferroelectric RAM (FRAM), a ROM, a programmable ROM (PROM), an electrically programmable ROM (EPROM), an electrically erasable PROM (EEPROM), a flash memory, a magnetic surface memory, an optical disk, or a CD-ROM, or may be any device including one of or any combination of the foregoing memories.

In some embodiments, the executable instruction may be written in a form of a program, software, a software module, a script, or code and according to a programming language (including a compiler or interpreter language or a declarative or procedural language) in any form, and may be deployed in any form, including an independent program or a module, a component, a subroutine, or another unit suitable for use in a computing environment.

As an example, the executable instruction may be deployed to be executed on an electronic device, or deployed to be executed on a plurality of electronic devices at the same position, or deployed to be executed on a plurality of electronic devices that are distributed in a plurality of positions and interconnected by using a communication network.

The foregoing descriptions are merely embodiments of this application, and are not intended to limit the protection scope of this application. Any modification, equivalent replacement, or improvement made within the spirit and scope of this application shall fall within the protection scope of this application.

What is claimed is:

1. A method for processing an interaction in a virtual scene performed by an electronic device, the method comprising:
displaying a virtual scene, the virtual scene comprising a first account and a second account that participate in interaction;
displaying at least one first cell and at least one second cell in the virtual scene, the first cell being configured for the first account to place at least one first virtual object, to interact with at least one second virtual object placed in the second cell by the second account; and
in response to an end of each round of interaction, updating a quantity of cells comprised in the virtual scene.

2. The method according to claim 1, wherein
the at least one first cell is located in a first area of the virtual scene, and the at least one second cell is located in a second area of the virtual scene, the first area and the second area are two areas that are independent of each other in the virtual scene; and
the updating a quantity of cells comprised in the virtual scene comprises:
adding at least one first cell in the first area, and adding at least one second cell in the second area.

3. The method according to claim 2, wherein the adding at least one first cell in the first area comprises:
adding, in the first area, at least one first cell to at least one position adjacent to edge cells in the at least one first cell according to a fixed sequence or randomly.

4. The method according to claim 2, wherein the adding at least one first cell in the first area comprises:
executing one of the following processes:
adding a fixed quantity of the first cells in the first area;
adding a first quantity of the first cells in the first area, the first quantity being positively correlated to a quantity of interaction rounds that have been performed currently;
adding a second quantity of the first cells in the first area, the second quantity being positively correlated to a quantity of first virtual objects placed in a preparation area of the virtual scene by the first account; and
adding a third quantity of the first cells in the first area, the third quantity being negatively correlated to a quantity of the existing first cells in the first area.

5. The method according to claim 2, further comprising:
displaying, in response to the first account winning in a current round of interaction, at least one addition identifier in the first area; and
adding, in response to a selection operation on the at least one addition identifier, one first cell to a position where the selected addition identifier is located.

6. The method according to claim 2, wherein a display style of the newly added cells in the virtual scene is different from a display style of the existing cells in the virtual scene, and when a next round of interaction starts, the display style of the newly added cells is adjusted to be the same as the display style of the existing cells.

7. The method according to claim 1, wherein the updating a quantity of cells comprised in the virtual scene comprises:
adding, in response to the first account winning in the current round of interaction, at least one first cell in the virtual scene, and keeping a quantity of the at least one second cell unchanged; and
keeping, in response to the first account losing in the current round of interaction, the quantity of the at least one first cell unchanged in the virtual scene, and adding at least one second cell.

8. The method according to claim 1, wherein the updating a quantity of cells comprised in the virtual scene comprises:
adding, in response to the first account winning in the current round of interaction, at least one first cell in the virtual scene, and canceling displaying of at least one second cell; and
canceling, in response to the first account losing in the current round of interaction, displaying of at least one first cell in the virtual scene, and adding at least one second cell.

9. The method according to claim 1, wherein the updating a quantity of cells comprised in the virtual scene comprises:
keeping, in response to the first account winning in the current round of interaction, the quantity of the at least one first cell unchanged in the virtual scene, and canceling displaying of at least one second cell; and
canceling, in response to the first account losing in the current round of interaction, displaying of at least one first cell in the virtual scene, and keeping a quantity of the at least one second cell unchanged.

10. The method according to claim 1, wherein the updating a quantity of cells comprised in the virtual scene comprises:
adding, in response to the first account winning in the current round of interaction, a fourth quantity of the first cells in the virtual scene, and adding a fifth quantity of the second cells; and
adding, in response to the first account losing in the current round of interaction, the fifth quantity of the first cells in the virtual scene, and adding the fourth quantity of the second cells,
wherein the fourth quantity is greater than the fifth quantity.

11. The method according to claim 1, wherein the updating a quantity of cells comprised in the virtual scene comprises:
canceling, in response to the first account winning in the current round of interaction, displaying of a sixth quantity of the first cells in the virtual scene, and canceling displaying of a seventh quantity of the second cells; and
canceling, in response to the first account losing in the current round of interaction, displaying of the seventh quantity of the first cells in the virtual scene, and canceling displaying of the sixth quantity of the second cells,
wherein the sixth quantity is less than the seventh quantity.

12. The method according to claim 1, wherein the at least one first cell and the at least one second cell are distributed in the virtual scene in a staggered manner, the quantity of the first virtual objects that can be placed in each first cell is positively correlated to a size of the first cell, and the quantity of the second virtual objects that can be placed in each second cell is positively correlated to a size of the second cell.

13. An electronic device, comprising:
a memory, configured to store a computer-executable instruction or a computer program; and
a processor, configured to implement, when executing the computer-executable instruction or the computer program stored in the memory, a method for processing an interaction in a virtual scene including:
displaying a virtual scene, the virtual scene comprising a first account and a second account that participate in interaction;
displaying at least one first cell and at least one second cell in the virtual scene, the first cell being configured for the first account to place at least one first virtual object, to interact with at least one second virtual object placed in the second cell by the second account; and
in response to an end of each round of interaction, updating a quantity of cells comprised in the virtual scene.

14. The electronic device according to claim 13, wherein the at least one first cell is located in a first area of the virtual scene, and the at least one second cell is located in a second area of the virtual scene, the first area and the second area are two areas that are independent of each other in the virtual scene; and
the updating a quantity of cells comprised in the virtual scene comprises:
adding at least one first cell in the first area, and adding at least one second cell in the second area.

15. The electronic device according to claim 13, wherein the updating a quantity of cells comprised in the virtual scene comprises:
adding, in response to the first account winning in the current round of interaction, at least one first cell in the virtual scene, and keeping a quantity of the at least one second cell unchanged; and
keeping, in response to the first account losing in the current round of interaction, the quantity of the at least one first cell unchanged in the virtual scene, and adding at least one second cell.

16. The electronic device according to claim 13, wherein the updating a quantity of cells comprised in the virtual scene comprises:
adding, in response to the first account winning in the current round of interaction, at least one first cell in the virtual scene, and keeping a quantity of the at least one second cell unchanged; and
keeping, in response to the first account losing in the current round of interaction, the quantity of the at least one first cell unchanged in the virtual scene, and adding at least one second cell.

17. The electronic device according to claim 13, wherein the updating a quantity of cells comprised in the virtual scene comprises:
adding, in response to the first account winning in the current round of interaction, at least one first cell in the virtual scene, and canceling displaying of at least one second cell; and
canceling, in response to the first account losing in the current round of interaction, displaying of at least one first cell in the virtual scene, and adding at least one second cell.

18. The electronic device according to claim 13, wherein the updating a quantity of cells comprised in the virtual scene comprises:
canceling, in response to the first account winning in the current round of interaction, displaying of a sixth quantity of the first cells in the virtual scene, and canceling displaying of a seventh quantity of the second cells; and
canceling, in response to the first account losing in the current round of interaction, displaying of the seventh quantity of the first cells in the virtual scene, and canceling displaying of the sixth quantity of the second cells,
wherein the sixth quantity is less than the seventh quantity.

19. The electronic device according to claim 13, wherein the at least one first cell and the at least one second cell are distributed in the virtual scene in a staggered manner, the quantity of the first virtual objects that can be placed in each first cell is positively correlated to a size of the first cell, and the quantity of the second virtual objects that can be placed in each second cell is positively correlated to a size of the second cell.

20. A non-transitory computer-readable storage medium, having a computer-executable instruction or a computer program stored therein, the computer-executable instruction or the computer program, when executed by a processor of an electronic device, causing the electronic device to implement a method for processing an interaction in a virtual scene including:
displaying a virtual scene, the virtual scene comprising a first account and a second account that participate in interaction;
displaying at least one first cell and at least one second cell in the virtual scene, the first cell being configured for the first account to place at least one first virtual object, to interact with at least one second virtual object placed in the second cell by the second account; and
in response to an end of each round of interaction, updating a quantity of cells comprised in the virtual scene.
